(19) United States
(12) Patent Application Publication
(10) Pub. No.: US 2014/0347756 A1
(43) Pub. Date: Nov. 27, 2014

(54) Suspended Solar Field

(71) Applicant: Brenmiller Energy Consulting Ltd., Tel Aviv (IL)

(72) Inventors: Avi Brenmiller, Ramat Hasharon (IL); Dan Raz, Haifa (IL)

(73) Assignee: Brenmiller Energy Consulting Ltd., Tel Aviv (IL)

(21) Appl. No.: 13/898,491

(22) Filed: May 21, 2013

(51) Int. Cl. G02B 7/183; B21D 53/00; B08B 1/00; E02D 5/22

(52) U.S. Cl. CPC G02B 7/183; E02D 5/22; B21D 53/00; B08B 1/00
USPC 359/853; 29/890.033; 15/250.003

(57) ABSTRACT

A method for erecting a solar field includes inserting piles into the ground in a predefined pattern covering an area of the solar field, and deploying rails between the piles. Elements of an array of solar collectors are transported along the rails to respective deployment locations in the solar field. The solar collectors are erected on the piles using the elements at the respective deployment locations.

### FIELD OF THE INVENTION

The present invention relates generally to solar energy systems, and particularly to solar thermal energy generation.

### BACKGROUND

In solar thermal energy systems, the rays of the sun are concentrated to heat a fluid to high temperature (generally in the range of 300-550° C.). Typically, the heated fluid is piped from the solar concentrator to drive a turbine in order to generate electricity. Various types of concentrator geometries are known in the art, most notably parabolic troughs, comprising long parabolic reflectors with a pipe containing the heat-transfer fluid running along the focal line of the reflectors. The troughs typically rotate in the course of the day to track the motion of the sun. Large-scale assemblies of multiple, parallel solar troughs of this sort are sometimes referred to as “solar fields.”

### SUMMARY

Embodiments of the present invention that are described hereinbelow provide improved designs for solar fields, as well as systems and techniques for erection of such solar fields.

There is therefore provided, in accordance with an embodiment of the present invention, a method for erecting a solar field, which includes inserting piles into the ground in a predefined pattern covering an area of the solar field, and deploying rails between the piles. Elements of an array of solar collectors are transported along the rails to respective deployment locations in the solar field. The solar collectors are erected on the piles using the elements at the respective deployment locations.

In the disclosed embodiments, the piles have lower ends, which are inserted into the ground, and upper ends, which support the rails and the solar collectors, and inserting the piles includes leveling the upper ends of the piles so that the rails and solar collectors are horizontal. Typically, leveling the upper ends includes inserting the piles so that the piles have different, respective lengths protruding above the ground in order to compensate for variations in a terrain of the area.

In some embodiments, deploying the rails includes erecting first rails along a first direction, and the method includes deploying second rails in a second direction, perpendicular to the first direction and intersecting with the first rails. In a disclosed embodiment, the solar collectors include solar troughs, and erecting the first rails includes deploying multiple pairs of the first rails, wherein each pair of the first rails is located between a corresponding pair of the solar troughs.

Additionally or alternatively, transporting the elements includes conveying the elements from a logistical facility along the second rails to an intersection with a pair of the first rails, and then conveying the elements from the intersection along the pair of the first rails to the respective deployment locations. In a disclosed embodiment, transporting the elements includes carrying the components on a wagon having a first set of wheels mounted so as to run along the first rails and a second set of wheels mounted perpendicular to the first set of wheels so as to run along the second rails. Transporting the elements may include releasing the second set of the wheels from the wagon after reaching the intersection. The logistical facility may be erected on a group of the piles. The method may also include, after erection of the solar collectors, performing maintenance operations on the solar field using wagons that travel along the rails.

In some embodiments, erecting the solar collectors includes deploying bases across respective pairs of the piles that are mutually adjacent in the pattern, and mounting the solar collectors on the bases. In a disclosed embodiment, the solar collectors include a trough including multiple modules having end segments, and wherein erecting the solar collectors includes connecting the modules end-to-end parallel to the rails while mounting the end segments on the bases. Typically, each module includes a frame, which includes the end segments, and multiple mirror segments held by the frame, and transporting the elements includes conveying components of the frame and conveying the mirror segments along the rails from a logistical facility to a respective deployment location of the module, while erecting the solar collectors includes assembling the module from the components at the deployment location, and then mounting the mirror segments on the frame. Conveying the components of the frame may include transporting the components on a transport wagon, while assembling the module includes conveying at least one utility wagon, including erection equipment, along the rails to the respective deployment location, and using the erection equipment on the utility wagon to unload and assemble the components at the respective deployment location.

Alternatively, the modules are assembled in a logistical facility, and transporting the elements includes conveying the assembled modules along the rails from the logistical facility to the respective deployment locations.

There is also provided, in accordance with an embodiment of the present invention, a solar thermal energy system, which includes a plurality of piles, which are inserted into the ground in a predefined pattern covering an area of a solar field. Rails are deployed between the piles for transporting elements of the solar field to respective deployment locations in the solar field. Multiple solar collectors are erected on the piles using the elements at the respective deployment locations.

In a disclosed embodiment, the system includes a cleaning wagon, which is configured to clean the solar collectors after erection of the system while traveling along the rails through the solar field.

There is additionally provided, in accordance with an embodiment of the present invention, apparatus for maintenance of a solar energy system. The apparatus includes a chassis, having wheels configured for travel along rails running between rows of solar collectors in a solar field. At least one cleaning assembly is mounted on the chassis and is configured to clean the solar collectors adjacent to the rails while the apparatus travels along the rails.

Typically, the at least one cleaning assembly is curved convexly so as to run along a concave surface of the solar collectors while the apparatus travels along the rails. In a disclosed embodiment, the at least one cleaning assembly includes a pair of cleaning assemblies for simultaneously cleaning the solar collectors on both sides of the rails.

The present invention will be more fully understood from the following detailed description of the embodiments thereof, taken together with the drawings in which:

### BRIEF DESCRIPTION OF THE DRAWINGS

FIG. 1A is a schematic, pictorial illustration showing a grid of piles in an area to be occupied by a solar field, in accordance with an embodiment of the present invention;

FIG. 1B is a schematic sectional illustration of the grid of piles shown in FIG. 1A, taken along the line IB-IB;

FIG. 2 is a schematic, pictorial illustration showing bases for solar troughs assembled on the piles of FIG. 1, in accordance with an embodiment of the present invention;

FIG. 3 is a schematic, pictorial illustration showing a pair of rails laid across the area of a solar field, in accordance with an embodiment of the present invention;

FIG. 4 is a schematic, pictorial illustration showing additional rails assembled on the piles of FIG. 1, perpendicular to the rails of FIG. 3, in accordance with an embodiment of the present invention;

FIG. 5A is a schematic, pictorial illustration showing a wagon traveling on rails across the area of a solar field under assembly, in accordance with an embodiment of the present invention;

FIG. 5B is a schematic, pictorial illustration showing the wagon of FIG. 5B at a rail intersection, in accordance with an embodiment of the present invention;

FIGS. 6A and 6B are schematic, pictorial illustrations showing successive steps in changing the direction of travel of the wagon of FIG. 5A at a rail intersection, in accordance with an embodiment of the present invention;

FIG. 7 is a schematic, pictorial illustration showing transport of components of a solar trough by a wagon on rails in a solar field under assembly, in accordance with an embodiment of the present invention;

FIG. 8 is a schematic, pictorial illustration showing assembly of solar troughs in a solar field, in accordance with an embodiment of the present invention;

FIG. 9 is a schematic, pictorial illustration showing the solar field of FIG. 8 following completion of the assembly of two solar troughs, in accordance with an embodiment of the present invention;

FIG. 10 is a schematic, pictorial illustration showing transport of a module of a solar trough by a wagon on rails in a solar field under assembly, in accordance with an alternative embodiment of the present invention;

FIG. 11 is a schematic, pictorial illustration of a cleaning wagon in operation in a solar field, in accordance with an embodiment of the present invention; and

FIG. 12 is a schematic, sectional illustration of the cleaning wagon of FIG. 11, together with solar troughs that it is cleaning, in accordance with an embodiment of the present invention.

### DETAILED DESCRIPTION OF EMBODIMENTS

### Overview

Solar thermal energy systems are often large-scale installations, covering an area of several hectares or more. A typical installation includes an array of solar collectors in the form of reflective, parabolic troughs arranged in multiple parallel rows covering the available space and topography. The troughs are driven by motors to rotate so as to track the sun's motion and focus solar energy onto heat transfer tubes containing a suitable heat transfer fluid. For these purposes, it is generally desirable that the troughs be mounted in straight rows on horizontal bases. By the same token, other types of solar collectors and arrays, such as heliostats in the field surrounding a “solar tower,” are typically mounted on a horizontal surface in a fixed, predetermined deployment pattern.

In many or most cases, however, the area that is allocated for a solar field has its own topography and is not flat or horizontal. Therefore, before installing the troughs, the usual practice is to level the entire area of the solar field. This practice often entails costly earthworks and environmental damage over a large area.

Embodiments of the present invention that are described hereinbelow provide a new approach to erecting a solar field, in which the components of the solar thermal energy system are suspended on a framework above the ground. This approach avoids the need for extensive earthworks and thus reduces financial and environmental costs relative to methods that are known in the art. In some cases, suspending the elements of the solar field in this manner is the only practical solution that is capable of meeting environmental impact constraints.

In the disclosed embodiments, piles are inserted into the ground along a predefined pattern covering the area of the solar field that is to be erected. The pattern may comprise a grid, or it may alternatively be a circular pattern or a more complex pattern, according to the design requirements of the solar field. Rails are then deployed above the ground between the piles. Elements of an array of solar collectors, such as components of the solar troughs, are transported along the rails to their respective deployment locations on the grid, where they are then used in assembling the troughs on bases suspended on the piles. The piles are typically inserted into the ground so that the upper ends of the piles, which support the rails and troughs, are level with one another, and the rails and troughs are thus horizontal. The piles may have different, respective lengths protruding above the ground in order to compensate for variations in the terrain of the solar field.

It is desirable in these embodiments that wagons carrying the trough components be able to travel over the rails from a logistical facility (which is typically set up at the edge of the solar field and may itself be built on the piles) to all locations in the field where troughs are to be erected. The trough components are held prior to assembly in this facility and may, optionally, be assembled into modules in the facility before they are deployed to their intended locations in the solar field. To enable the wagons to reach all locations in the field, pairs of rails may be deployed in two perpendicular directions: a first set of rails along the direction parallel to the solar troughs, and a second set of rails in a second direction, perpendicular to the first direction and intersecting with the first rails. Typically, each pair of the rails in the first set is located between a corresponding pair of the solar troughs, while the second set comprises a pair of rails leading to the logistical facility.

Thus, to transport components of the solar troughs to a given deployment location in the solar field, the components (as separate pieces or pre-assembled modules) are conveyed on a wagon from the logistical facility first along the second set of rails to an intersection with a pair of the first set of rails, and then from the intersection along the trough direction to the deployment location. In one embodiment, the wagon has a first set of wheels mounted so as to run along the first set of rails and a second set of wheels mounted perpendicular to the first set of wheels so as to run along the second set of rails. The second set of the wheels may be used only on the run between the logistical facility and the desired rail intersection, and may then be released from the wagon after reaching the intersection to enable the wagon to travel in the perpendicular direction.

In the embodiments that are described hereinbelow, in order to erect the solar troughs (or solar collectors of other types) on the piles, the bases of the troughs are first deployed across respective pairs of the piles that are mutually adjacent in the grid, and the solar troughs are then mounted on the bases. Typically, the solar trough is made up of multiple modules, which are connected end-to-end along a direction parallel to the rails, and the end segments of each such module are mounted on the bases.

The techniques and apparatus that are disclosed in the present patent application may be applied in assembling solar fields of a wide range of different designs. The collectors in these solar fields may comprise troughs of various design, or solar collectors of different geometries, such as paraboloidal mirrors.

For the sake of clarity of explanation, however, the embodiments that are shown in the figures and are described in detail hereinbelow refer specifically to the solar thermal energy system that is described in an Israel Patent Application entitled “Modular Solar Field,” filed Mar. 24, 2013 (attorney docket number 1205-1002), whose disclosure is incorporated herein by reference. In this system, each solar trough is made up of modules, wherein each module comprises a frame made up of end segments and other structural elements. The frame has an outer edge with a circular profile and an inner edge of parabolic profile, which holds multiple mirror segments. A motorized drive rotates the outer edge of the frame about the center line of the frame, which is also the focal line of the parabolic profile, in order to track the sun's motion. The heat transfer fluid flows through a heat transfer tube that is held stationary along this center line, and absorbs heat from the sun that is concentrated by the parabolic mirror segments.

In one embodiment of the present invention, the components of the frame and the mirror segments are conveyed along the rails from the logistical facility to the deployment location of the module. The frame of the module is then assembled in situ from these components at the deployment location, and the mirror segments are then mounted on the frame. Alternatively, as noted earlier the modules may be assembled in the logistical facility, and then transported along the rails to their deployment locations. Various types of special-purpose wagons may be used for transporting, unloading, and assembling the solar collectors in place. After the solar field has been assembled and is operational, the rails may continue to be used for purposes of maintenance.

### Implementation Example

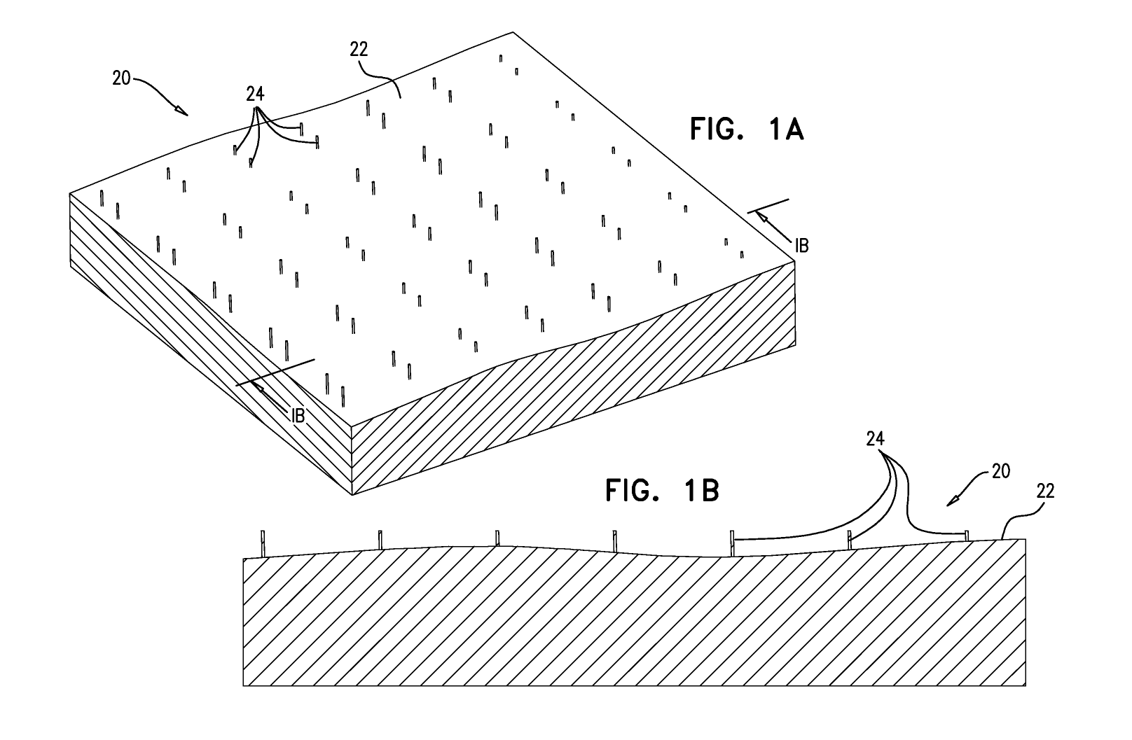

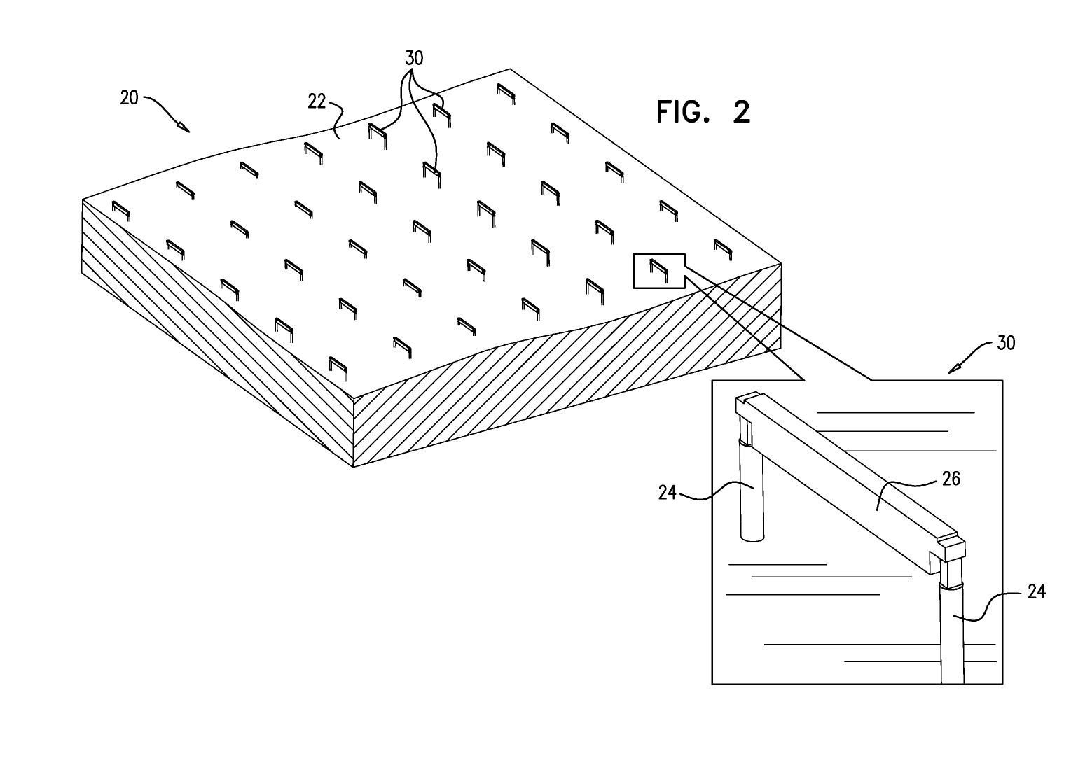

Reference is now made to FIGS. 1A and 1B, which schematically illustrate a grid of piles 24 in the area to be occupied by a solar field 20, in accordance with an embodiment of the present invention. FIG. 1A is a pictorial view, while FIG. 1B is a sectional view taken along the line IB-IB in FIG. 1A. In this initial stage of erection of solar field 20, piles 24 have been inserted into ground 22. Any suitable method that is known in the art may be used to drive the piles into the ground or to cast the piles in suitably-drilled holes, so as to provide the required structural stability for the components of the solar field. Alternatively, in some cases the piles may be replaced by columns that are mounted on the ground.

As shown in the figures, the surface of ground 22 is not horizontal, and piles 24 are therefore inserted to different depths, with different lengths protruding above the ground. Thus, the upper ends of the piles are level with one another, defining a horizontal plane, without requiring that the ground be leveled. Although all the piles in the pictured field reach the same horizontal level, in alternative embodiments (not shown in the figures), on strongly sloping terrain, the piles may be arranged in groups at different elevations, to define two or more different, stepped levels. (In this case, the layout of the rails on the piles will be modified, relative to the single-plane design described below.) Further alternatively, the upper ends of the piles may define a plane that is tilted, rather than horizontal, for example tilted toward the south (in the Northern Hemisphere) or toward the north (in the Southern Hemisphere).

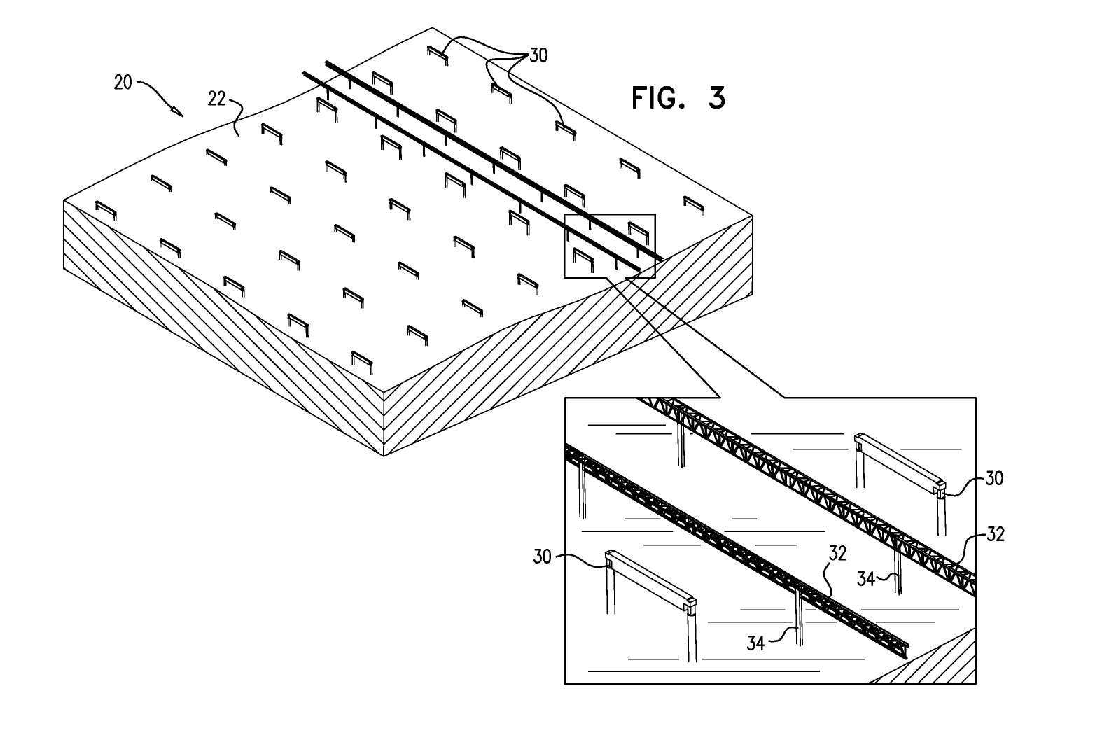

FIG. 2 is a schematic, pictorial illustration showing bases 30 for solar troughs assembled on piles 24, in accordance with an embodiment of the present invention. As shown in the inset, each base 30 is assembled by fastening a crossbar 26 between an adjacent pair of piles 24. The crossbar may include an adjustment mechanism (not shown) to facilitate leveling of the crossbar to adjust for any height variations among the piles.

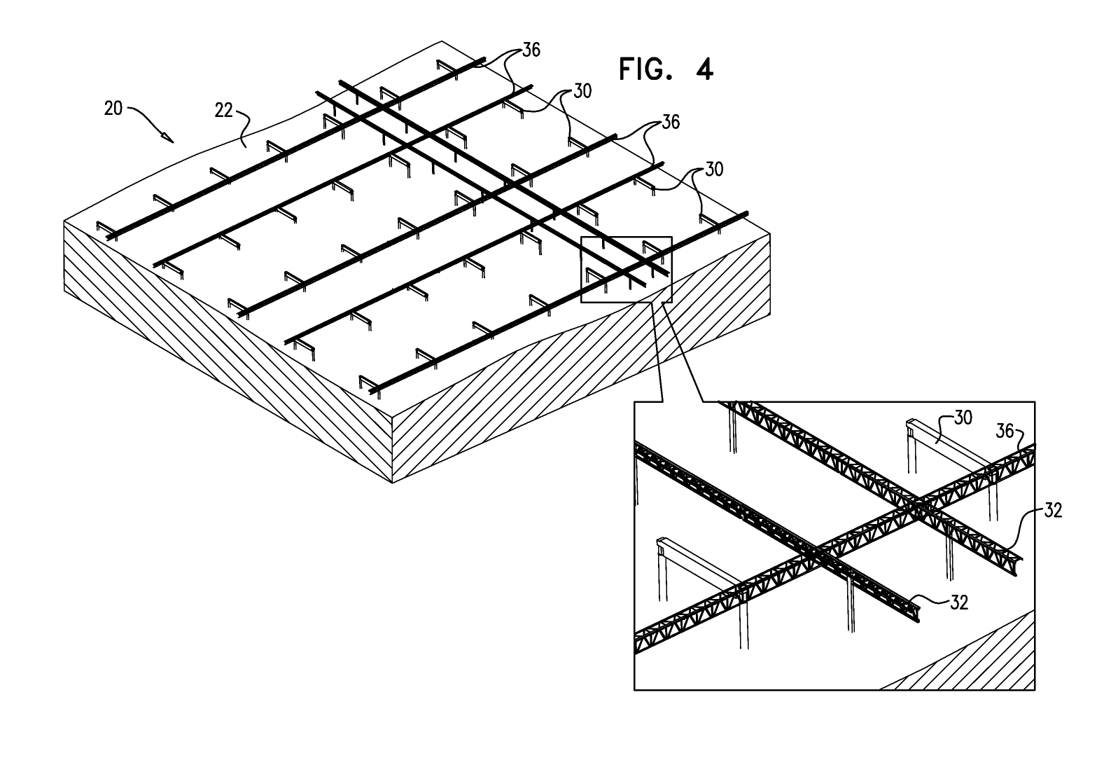

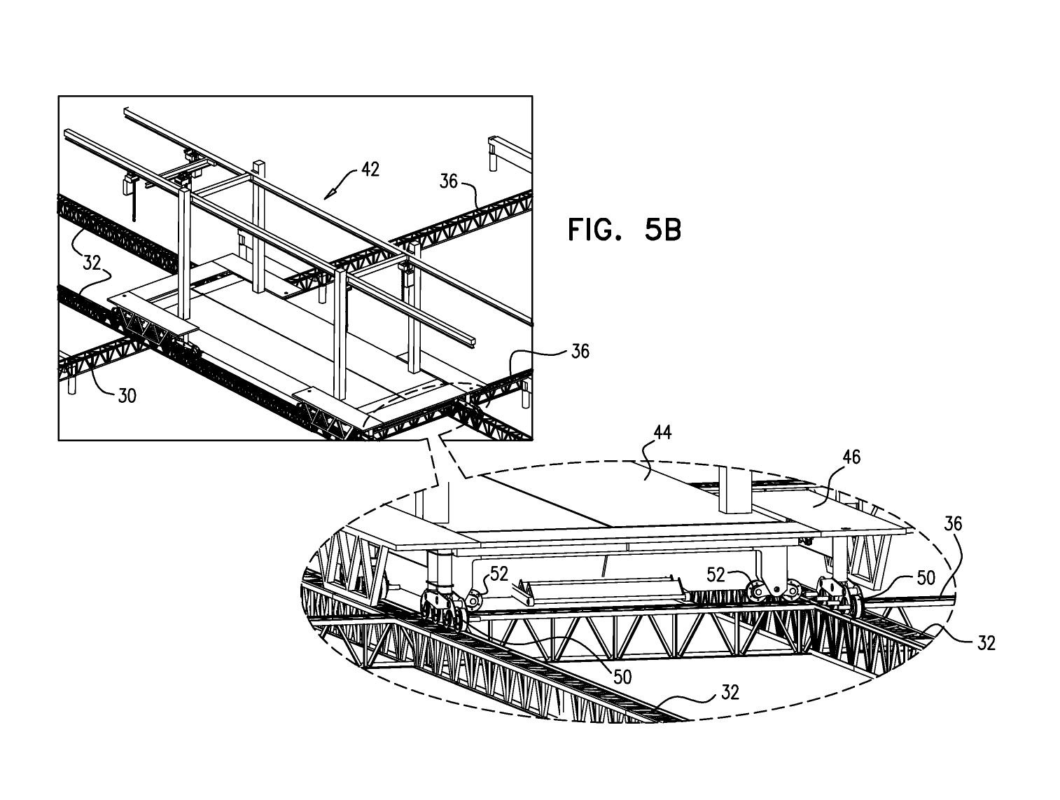

FIG. 3 is a schematic, pictorial illustration showing a pair of rails 32 laid across the area of solar field 20, in accordance with an embodiment of the present invention. Rails 32 are mounted horizontally on piles 34, at a height roughly equal to that of bases 30. These rails run transversely across the field in a direction perpendicular to the solar troughs that are to be erected, in order to connect the field to a logistical facility at the edge of the field (as shown in FIG. 5A and subsequent figures). Only a single pair of these transverse rails is shown in the figures, but in larger, more complex installations, there may be multiple transverse rail pairs of this sort.

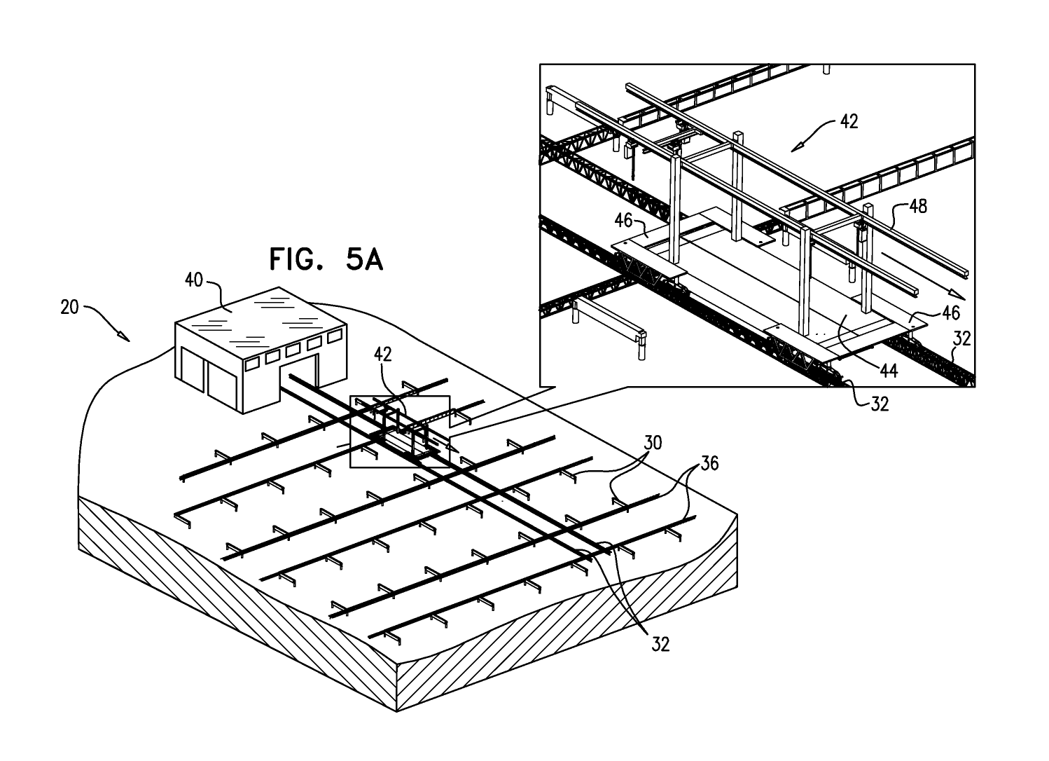

FIG. 4 is a schematic, pictorial illustration showing longitudinal rails 36 assembled on bases 30, perpendicular to rails 32, in accordance with an embodiment of the present invention. As shown in the figures that follow, rails 36 form pairs, which are mounted at the inner edges of adjacent rows of bases 30, so that a wagon can travel along rails 36 between adjacent solar troughs. Each rail 36 intersects rails 32, so as to allow wagons to be transferred between the transverse and longitudinal directions of travel. Typically, the longitudinal axes of the troughs run north-south, and thus so do rails 36, while rails 32 run east-west.

FIGS. 5A and 5B are schematic, pictorial illustrations showing a wagon 42 traveling on rails 32 across the area of solar field 20 under assembly, in accordance with an embodiment of the present invention. FIG. 5A shows wagon 42 leaving a logistical facility 40 to travel across the field on rails 32, while FIG. 5B shows the wagon at an intersection of rails 32 with a pair of rails 36. Wagons may travel over rails 32 and 36 either under direct operator control or robotically.

Logistical facility 40 is used, as noted above, to store components of the solar troughs during the process of erection, and possibly for pre-assembly of certain components and modules before their deployment over the rails to their respective locations. The logistical facility may itself be erected on a certain group of piles 24 when necessary due to limited space availability or other environmental constraints. After erection is complete, facility 40 may continue to be used for purposes of maintenance or, additionally or alternatively, to contain operational elements of the solar field, such as generator turbines or other equipment.

Wagon 42 comprises a chassis 44, with an optional superstructure 48 for use in mounting and lifting components that are loaded onto and unloaded from the chassis. Docking fenders 46 are removably attached to the front and rear of wagon 42 during transport along rails 32. As shown in the inset of FIG. 5B, fenders 46 have wheels 50 that are oriented to run along rails 32, while chassis 44 has its own wheels 52 that are oriented perpendicularly, to run along rails 36. During travel along rails 32, wheels 52 (or possibly chassis 44 as a whole) are typically lifted sufficiently to allow them to pass over rails 36 without engaging them. The intersection between rails 32 and 36 is constructed, however, so as to allow either wheels 50 or wheels 52 to run across the intersection in the transverse or longitudinal direction, as appropriate.

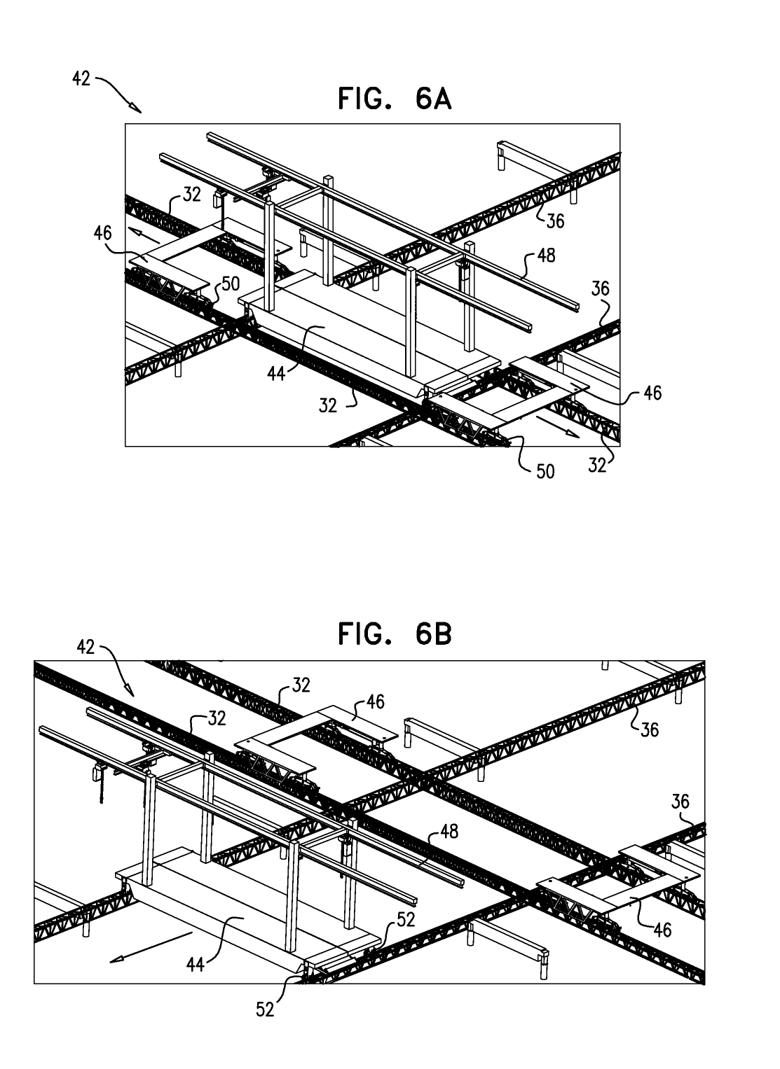

FIGS. 6A and 6B are schematic, pictorial illustrations showing successive steps in changing the direction of travel of wagon 42 at a rail intersection, in accordance with an embodiment of the present invention. After the wagon reaches the desired intersection on rails 32 (as shown in FIG. 5B), wheels 52 are lowered onto rails 36, and fenders 46 are detached and rolled away from the wagon along rails 32 on wheels 50. Wagon 42 is then free to travel longitudinally along rails 36 on wheels 52, as shown in FIG. 6B. Fenders 46 may be wheeled away to dock with and transport another wagon to or from facility 40; or they may remain in place until wagon 42 has been unloaded, for example, and then return the wagon to facility 40 to get another load.

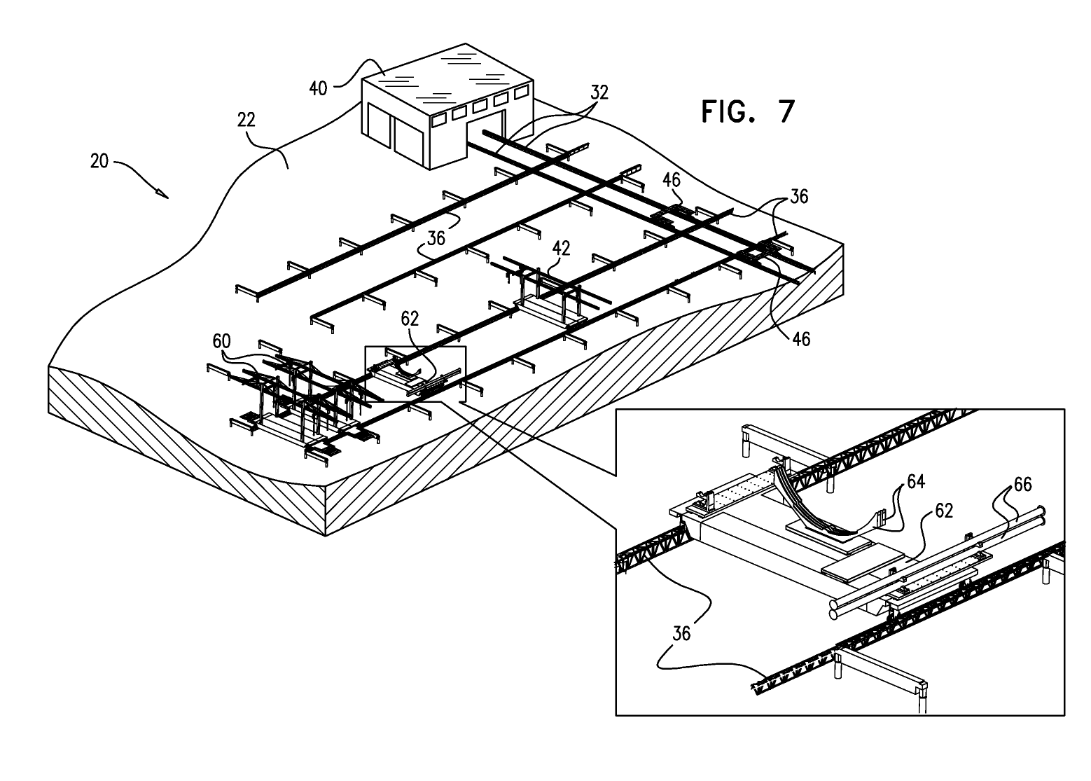

FIG. 7 is a schematic, pictorial illustration showing transport of components of a solar trough by a transport wagon 62 on rails 36 during assembly of solar field 20, in accordance with an embodiment of the present invention. The components carried by wagon 62 in this example are elements of the frame of a solar trough module, including parts of end segments 64 and torque tubes 66. (The functions of these elements are explained in detail in the above-mentioned Israeli patent application.) By the same token, wagon 62 may be used to carry other components for assembly, such as the mirror segments and the heat transfer tube.

Utility wagons of various types may be used in unloading and assembling the components of the solar troughs transport wagons 62 and assembling the components in the desired deployment location. Such utility wagons similarly travel along rails 32 and 36 and may comprise various sorts of erection equipment, such as special-purpose tools and jigs, climbing stairs, cranes and levers. In the pictured example, the utility wagons that are in use include one or more cranes 60, which are mounted on their own wagons, are used to lift the components from wagon 62 and move them to the appropriate locations for assembly on bases 30.

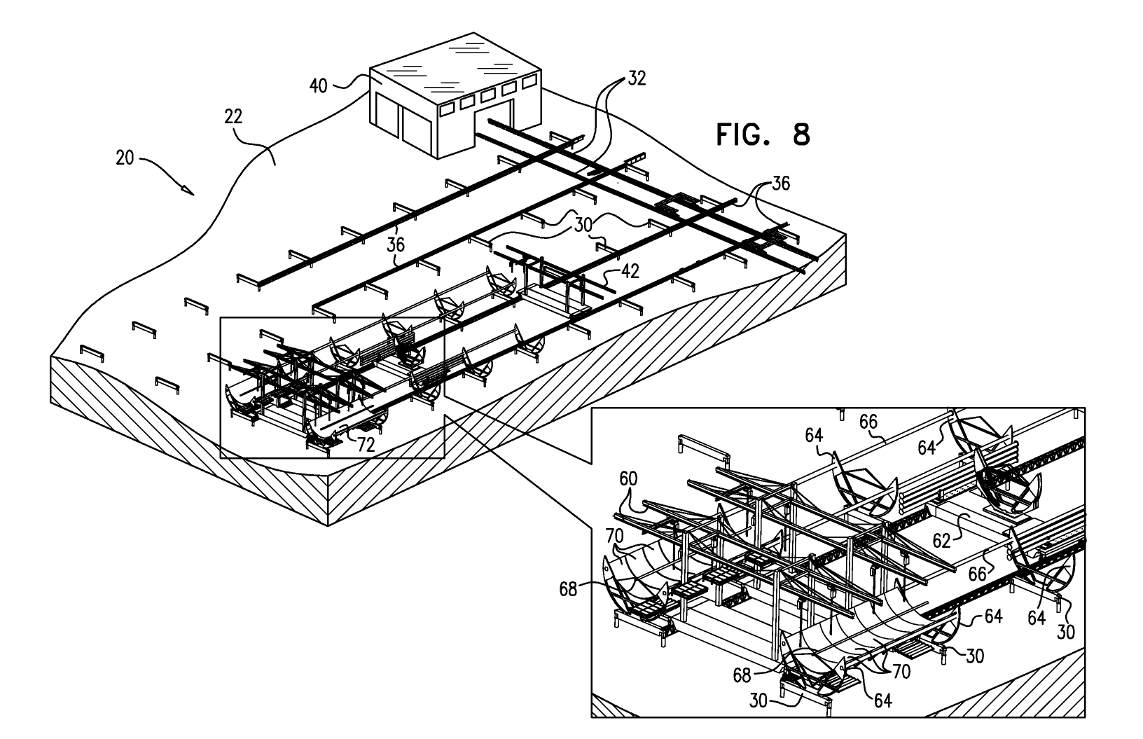

FIG. 8 is a schematic, pictorial illustration showing assembly of solar trough modules 72 in solar field 20, in accordance with an embodiment of the present invention. Each module 72 comprises a pair of end segments 64, which are mounted on respective bases 30. The modules are connected end-to-end to make up each trough, as shown in the figure, and adjoining modules along a given trough may share the same end segment. A pair of torque tubes 66 connect the two end segments 64 in each module 72, thus defining and providing rigidity to the frame of the module. (The frame also includes underlying trusses and mirror supports, which are typically assembled after the end segments and torque tubes have been erected in place, but these elements are not shown in the figures.) All of these components are conveyed to the appropriate locations by wagon 62, where they are then unloaded and assembled in place using cranes 60.

After the frame of a given module 72 has been assembled, mirror segments 70 are transported to the module location, by wagon 62 or by another wagon, and are then lifted into place on the frame. The mirror segments thus form a parabolic mirror within each module. Segments of a heat transfer tube 68 are likewise conveyed to the modules, mounted in place along the focal line of the mirror, and joined together to produce a continuous tube along the entire length of the trough.

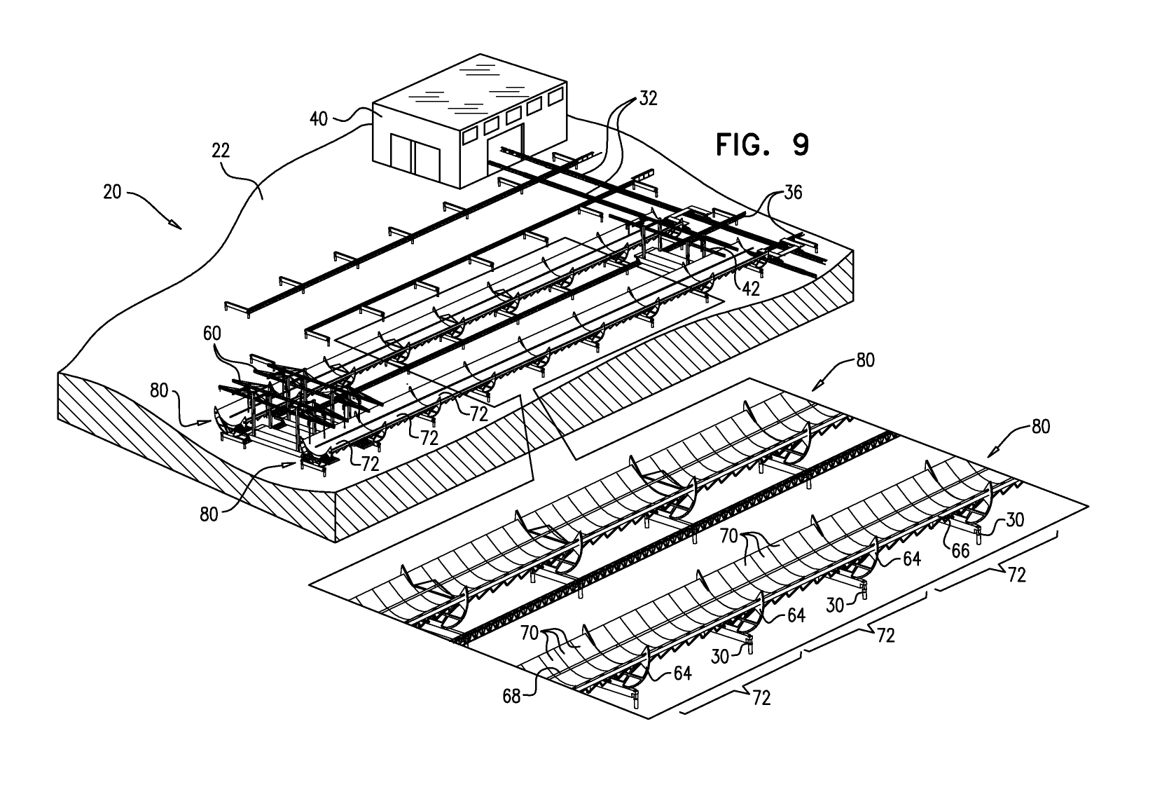

FIG. 9 is a schematic, pictorial illustration of solar field 20 following completion of the assembly of two solar troughs 80, in accordance with an embodiment of the present invention. Each trough 80 now comprises an entire row of modules 72, as described above, extending longitudinally to either side of the corresponding pair of rails 36. Heat transfer tube 68 extends along the entire length of each trough and is connected in a circuit to supply heated fluid to the generator turbine and receive cool fluid in return. Motorized drives (not shown) drive end segments 64 to rotate on bases 30, in order to turn each trough 80 during the course of a day to track the sun.

After completing a pair of troughs 80 in this manner, wagons 42 and 62, as well as cranes 60, may be shifted along rails 32 to the next set of rails 36 in order to begin assembly of the next two troughs. The rails remain in place after assembly of the entire field has been completed and may continue to be used for service, maintenance and cleaning activities as required. Special-purpose wagons may be provided for these purposes, as well, as described below.

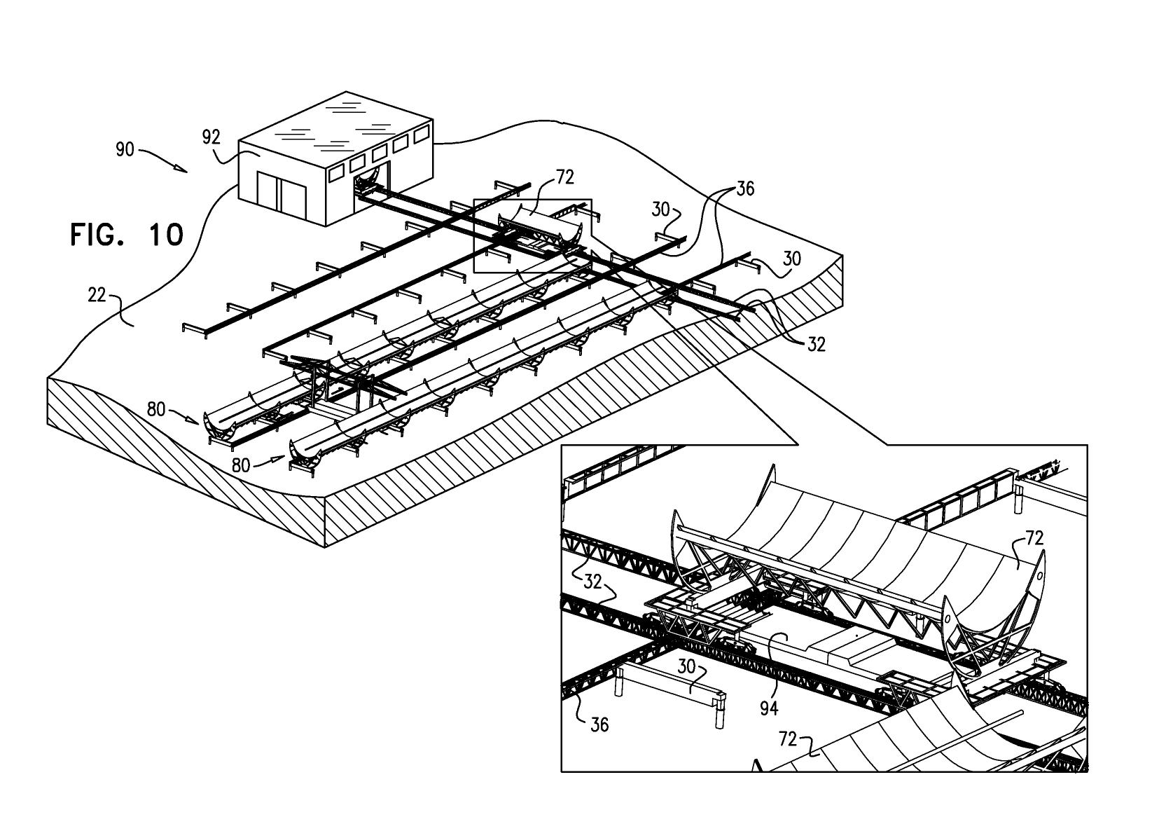

FIG. 10 is a schematic, pictorial illustration showing a solar field 90 under assembly, in accordance with an alternative embodiment of the present invention. In this embodiment, rather than assembling trough modules in situ, modules 72 are assembled in an expanded logistical facility 92. A wagon 94 then transports the assembled modules along rails 32 and 36 to the designated locations, where they are assembled into troughs 80.

In other embodiments (not shown in the figures), the trough modules may be partially assembled in a logistical facility, and these subassemblies may then be transported to the appropriate locations so that assembly can be completed in situ.

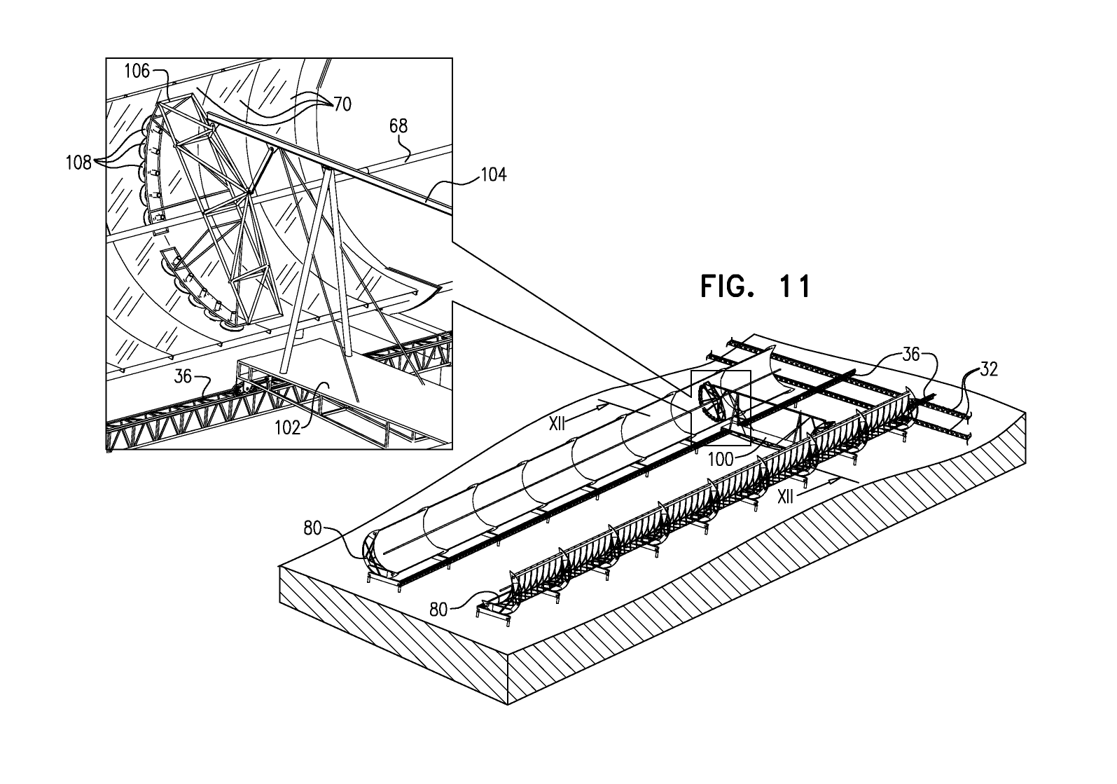

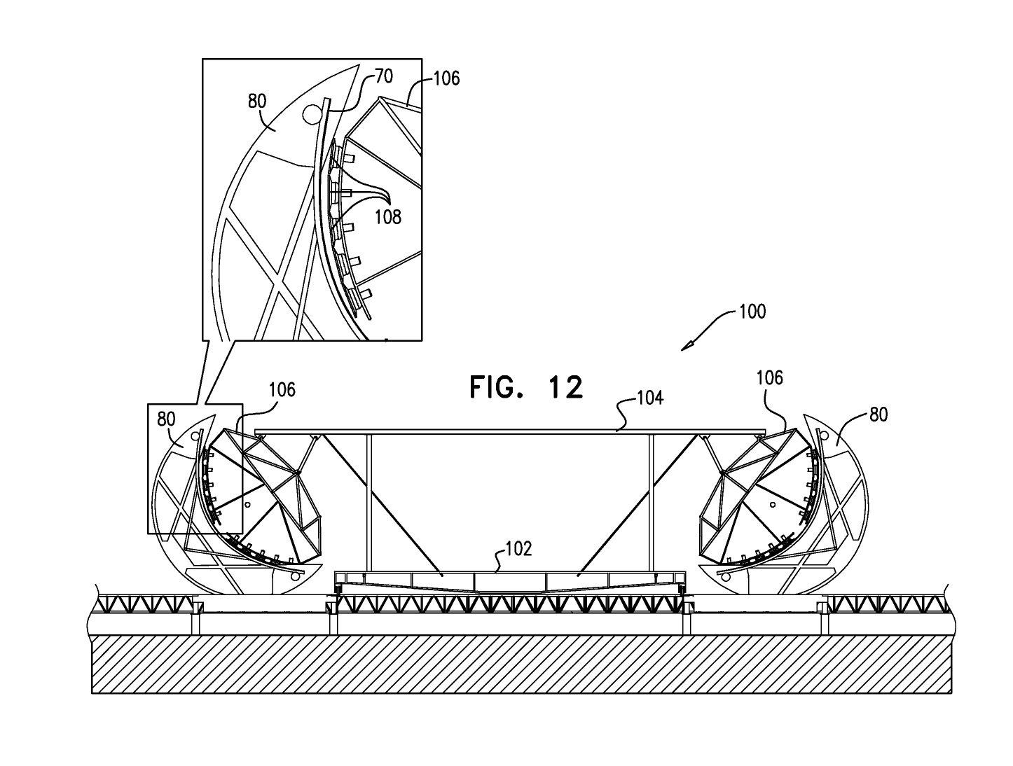

Reference is now made to FIGS. 11 and 12, which schematically illustrate a cleaning wagon 100 in operation in a solar field, in accordance with an embodiment of the present invention. FIG. 11 is a pictorial illustration, while FIG. 12 is sectional illustration taken along the line XII-XII in FIG. 11. Wagon 100 is shown here as an example of the continued use of rails 32 and 36 in maintaining the solar field in operation, after its erection has been completed.

Wagon 100 comprises a chassis 102, which travels on rails 32 and 36 in the same manner as the wagons used in assembling the solar field. A superstructure 104 of the wagon holds a pair of cleaning assemblies 106, for cleaning troughs 80 on both sides of rails 36. (During the cleaning operation, the troughs are both rotated to face toward the rails, as shown in the figures.) Each cleaning assembly holds multiple cleaning pads 108 on a frame that is curved convexly to match the concave profile of the troughs. As wagon 100 travels along the rails, pads 108 pass over mirror segments 70 and remove accumulated dirt, which otherwise can impair the performance of the troughs. Optionally, water or another cleaning solvent may be sprayed or otherwise spread over the mirror segments in conjunction with the operation of the cleaning pads.

Typically, wagon 100 performs this cleaning operation at night automatically or under remote control by an operator. Alternatively or additionally, this same sort of cleaning approach may be used for daytime cleaning, and the wagon may be controlled by an operator on the wagon itself. After completing a cleaning pass over one pair of troughs 80, wagon 100 travels on rails to the next pair and repeats the procedure there. Additionally or alternatively, multiple wagons of this sort may be provided for cleaning different trough pairs simultaneously.

Although the embodiments described above refer, by way of illustration, to certain specific designs of solar field components, the principles of these embodiments may similarly be applied in assembling a solar field of substantially any suitable design. For example, as noted earlier, the principles of the present invention may be applied in solar fields containing other types of solar troughs, as well as in erecting and maintaining solar fields in which paraboloidal heliostats focus solar energy onto a solar tower. All such alternative applications and implementations are considered to be within the scope of the present invention.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for erecting a solar field, comprising:
inserting piles into the ground in a predefined pattern covering an area of the solar field;
deploying rails between the piles;
transporting elements of an array of solar collectors along the rails to respective deployment locations in the solar field; and
erecting the solar collectors on the piles using the elements at the respective deployment locations.

2. The method according to claim 1, wherein the piles have lower ends, which are inserted into the ground, and upper ends, which support the rails and the solar collectors, and inserting the piles comprises leveling the upper ends of the piles so that the rails and solar collectors are horizontal.

3. The method according to claim 2, wherein leveling the upper ends comprises inserting the piles so that the piles have different, respective lengths protruding above the ground in order to compensate for variations in a terrain of the area.

4. The method according to claim 1, wherein deploying the rails comprises erecting first rails along a first direction, and the method comprises deploying second rails in a second direction, perpendicular to the first direction and intersecting with the first rails.

5. The method according to claim 4, wherein the solar collectors comprise solar troughs, and wherein erecting the first rails comprises deploying multiple pairs of the first rails, wherein each pair of the first rails is located between a corresponding pair of the solar troughs.

6. The method according to claim 4, wherein transporting the elements comprises conveying the elements from a logistical facility along the second rails to an intersection with a pair of the first rails, and then conveying the elements from the intersection along the pair of the first rails to the respective deployment locations.

7. The method according to claim 6, wherein transporting the elements comprises carrying the components on a wagon having a first set of wheels mounted so as to run along the first rails and a second set of wheels mounted perpendicular to the first set of wheels so as to run along the second rails.

8. The method according to claim 7, wherein transporting the elements comprises releasing the second set of the wheels from the wagon after reaching the intersection.

9. The method according to claim 6, and comprising erecting the logistical facility on a group of the piles.

10. The method according to claim 4, and comprising, after erection of the solar collectors, performing maintenance operations on the solar field using wagons that travel along the rails.

11. The method according to claim 1, wherein erecting the solar collectors comprises deploying bases across respective pairs of the piles that are mutually adjacent in the pattern, and mounting the solar collectors on the bases.

12. The method according to claim 11, wherein the solar collectors comprise a trough comprising multiple modules having end segments, and wherein erecting the solar collectors comprises connecting the modules end-to-end parallel to the rails while mounting the end segments on the bases.

13. The method according to claim 12, wherein each module comprises a frame, which comprises the end segments, and multiple mirror segments held by the frame, and
wherein transporting the elements comprises conveying components of the frame and conveying the mirror segments along the rails from a logistical facility to a respective deployment location of the module, and
wherein erecting the solar collectors comprises assembling the module from the components at the deployment location, and then mounting the mirror segments on the frame.

14. The method according to claim 13, wherein conveying the components of the frame comprises transporting the components on a transport wagon, and wherein assembling the module comprises conveying at least one utility wagon, comprising erection equipment, along the rails to the respective deployment location, and using the erection equipment on the utility wagon to unload and assemble the components at the respective deployment location.

15. The method according to claim 12, wherein the modules are assembled in a logistical facility, and wherein transporting the elements comprises conveying the assembled modules along the rails from the logistical facility to the respective deployment locations.

16. The method according to claim 1, and comprising, after erecting the solar collectors, cleaning the solar collectors using a cleaning wagon that travels along the rails through the solar field.

17. A solar thermal energy system, comprising:
a plurality of piles, which are inserted into the ground in a predefined pattern covering an area of a solar field;
rails deployed between the piles for transporting elements of the solar field to respective deployment locations in the solar field; and
multiple solar collectors, which are erected on the piles using the elements at the respective deployment locations.

18. The system according to claim 17, wherein the piles have lower ends, which are inserted into the ground, and upper ends, which support the rails and solar collectors, and which are leveled so that the rails and collectors are horizontal.

19. The system according to claim 18, wherein the piles have different, respective lengths protruding above the ground in order to compensate for variations in a terrain of the area.

20. The system according to claim 19, wherein the rails comprises first rails running along a first direction, and second rails running in a second direction, perpendicular to the first direction and intersecting with the first rails.

21. The system according to claim 20, wherein the solar collectors comprise solar troughs, and wherein the first rails are deployed in multiple pairs, wherein each pair of the first rails is located between a corresponding pair of the solar troughs.

22. The system according to claim 20, and comprising a wagon configured to transport the elements from a logistical facility along the second rails to an intersection with a pair of the first rails, and then from the intersection along the pair of the first rails to the respective deployment locations.

23. The system according to claim 22, wherein the wagon comprises a first set of wheels mounted so as to run along the first rails and a second set of wheels mounted perpendicular to the first set of wheels so as to run along the second rails.

24. The system according to claim 23, wherein the wagon is configured to release the second set of the wheels from the wagon after reaching the intersection.

25. The system according to claim 22, wherein the logistical facility is erected on a group of the piles.

26. The system according to claim 20, wherein the rails are configured, after erection of the solar collectors, to support maintenance operations performed on the solar field using wagons that travel along the rails.

27. The system according to claim 17, and comprising bases deployed across respective pairs of the piles that are mutually adjacent in the pattern, wherein the solar collectors are mounted on the bases.

28. The system according to claim 27, wherein the solar collectors comprise a trough comprising multiple modules, which are connected end-to-end parallel to the rails and which comprise respective end segments, which are mounted on the bases.

29. The system according to claim 28, wherein each module comprises a frame, which comprises the end segments, and multiple mirror segments held by the frame,
wherein the components of the frame and the mirror segments are conveyed along the rails from a logistical facility to a respective deployment location of the module, and
wherein the frame is assembled from the components at the deployment location, and then the mirror segments are then mounted on the frame.

30. The system according to claim 29, and comprising:
a transport wagon, configured to transport the components of the frame along the rails to the respective deployment location; and
at least one utility wagon, which is configured to travel along the rails to the respective deployment location, and which comprises erection equipment for use in unloading and assembling the components at the respective deployment location.

31. The system according to claim 28, wherein the modules are assembled in a logistical facility, and the assembled modules are conveyed along the rails from the logistical facility to the respective deployment locations.

32. The system according to claim 17, and comprising a cleaning wagon, which is configured to clean the solar collectors after erection of the system while traveling along the rails through the solar field.

33. Apparatus for maintenance of a solar energy system, the apparatus comprising:
a chassis, having wheels configured for travel along rails running between rows of solar collectors in a solar field; and
at least one cleaning assembly, which is mounted on the chassis and is configured to clean the solar collectors adjacent to the rails while the apparatus travels along the rails.

34. The apparatus according to claim 33, wherein the at least one cleaning assembly is curved convexly so as to run along a concave surface of the solar collectors while the apparatus travels along the rails.

35. The apparatus according to claim 33, wherein the at least one cleaning assembly comprises a pair of cleaning assemblies for simultaneously cleaning the solar collectors on both sides of the rails.
